(19) United States
(12) Patent Application Publication
(10) Pub. No.: US 2009/0293906 A1
(43) Pub. Date: Dec. 3, 2009

(54) Ultrasonic Cleaning of Engine Components

(75) Inventor: Nigel Baddeley, Lincoln (GB)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AKTIENGESELLSCHAFT, Munchen (DE)

(21) Appl. No.: 12/308,001

(22) PCT Filed: Jun. 4, 2007
(86) PCT No.: PCT/EP2007/055480

§ 371 Date: Dec. 4, 2008

(30) Foreign Application Priority Data
Jun. 24, 2006 (GB) 0612578.5

(51) Int. Cl. B08B 3/12

(52) U.S. Cl. 134/1; 134/104.2

(57) ABSTRACT

A method of cleaning an engine component, including: arranging a cap to provide a fluid seal with the engine component, wherein the cap includes an ultrasonic transducer and extends around a volume that is adjacent an exterior surface of the engine component; directing a cleaning fluid to contact the engine component via a supply conduit, wherein the directing involves the supply of cleaning fluid to said volume so as to contact said exterior surface; agitating the cleaning fluid by means of the ultrasonic transducer; and directing the cleaning fluid away from the component via a waste conduit.

### CROSS REFERENCE TO RELATED APPLICATIONS

This application is the US National Stage of International Application No. PCT/EP2007/055480, filed Jun. 4, 2007 and claims the benefit thereof. The International Application claims the benefits of British application No. 0612578.5 GB filed Jun. 24, 2006. Both of the applications are incorporated by reference herein in their entirety.

### FIELD OF INVENTION

The invention is concerned with the cleaning of engine components, particularly in the aerospace industry.

### BACKGROUND OF INVENTION

Internal combustion and gas turbine engines are complex mechanical systems with many internal components. The complexity of these machines means that routine maintenance and unscheduled repairs require the removal of the engines from service for significant lengths of time.

In most applications the service provided by gas turbine engines has a very high value compared with the cost of the engine itself. For example in gas pumping operations, the engines deliver huge quantities of gas across continents and in electricity generation applications, the fuel costs for one year can be greater than the value of the engine. In these and other applications of gas turbine or other engine types, there is an ongoing need to minimise the time that engines are out of service for repair and maintenance.

Many engine components include conduits for fluids such as fuel, air, lubricant etc. These conduits frequently become partially or totally blocked by dirt or debris, necessitating time consuming dismantling and cleaning. One such component is the pilot burner found in gas turbines, which maintains the combustion process at start-up and low engine loads. EP 0 728 989 and GB 2 336 663 provide further information on the role of the pilot burner in gas turbine engines.

A system that offers quick and effective cleaning of such components, particularly the internal fluid conduits, would offer significant advantages over the prior art.

### SUMMARY OF INVENTION

According to a first aspect of the present invention there is provided a method of cleaning an engine component, comprising: arranging a cap to provide a fluid seal with the engine component, the cap including an ultrasonic transducer; directing a cleaning fluid to contact the engine component via a supply conduit; agitating the cleaning fluid by means of the ultrasonic transducer; and directing the cleaning fluid away from the engine component via a waste conduit.

In a preferred embodiment, the engine component includes an internal fluid conduit (for example part of the fuel flow path during normal operation of the engine) and the cleaning fluid supply and waste conduits are arranged to direct cleaning fluid through said internal fluid conduit during the cleaning operation.

According to a second aspect of the present invention there is provided an apparatus for cleaning an engine component having an internal fluid conduit, comprising: a cap arranged to provide a fluid seal with the engine component and having an ultrasonic transducer located thereon; a supply conduit arranged to direct cleaning fluid to enter the internal fluid conduit; and a waste conduit arranged to collect cleaning fluid after exiting the internal fluid conduit.

### BRIEF DESCRIPTION OF THE DRAWINGS

The invention will now be described, by way of non-limiting example, with reference to the following figures in which:

FIG. 1 shows a schematic embodiment of the invention in a simple form;

FIG. 2 shows a preferred embodiment of the invention and

FIG. 3 shows a further preferred embodiment of the invention.

### DETAILED DESCRIPTION OF INVENTION

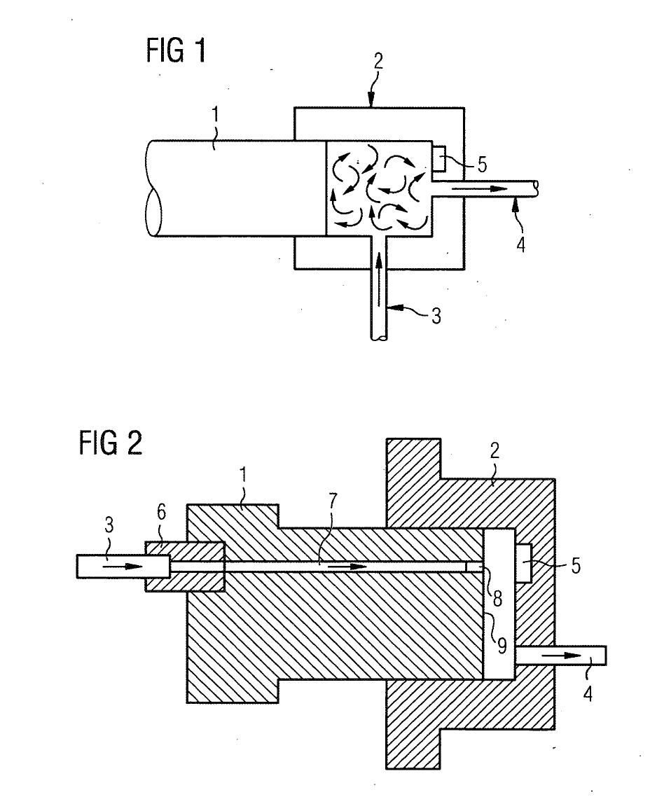

Referring to FIG. 1, an apparatus for cleaning an engine component 1 comprises a cap 2, a cleaning fluid supply conduit 3, a cleaning fluid waste conduit 4 and an ultrasonic transducer 5.

The apparatus is arranged to provide a fluid seal between component 1 and cap 2 such that, during operation, cleaning fluid (as represented by the arrows) is directed to contact with component 1 before being directed to waste via conduit 4. Transducer 5 provides ultrasonic agitation of the cleaning fluid to assist in cleaning.

The cleaning fluid is supplied from a source (not shown) that could be a pressurised vessel or a reservoir from which the fluid is pumped.

Referring to FIG. 2, the component 1, to be cleaned in a particular embodiment of the invention comprises a pilot burner for a gas turbine engine. Fuel inlet 6, is connected to an internal fluid (fuel) conduit 7 which (during operation) directs fuel to a nozzle 8. The cleaning fluid supply conduit 3 is connected to the fuel inlet 6 and the cleaning fluid waste conduit 4 is arranged to collect cleaning fluid after it emerges from nozzle 8 and contacts other surfaces 9 of the component 1.

As before, transducer 5 provides ultrasonic agitation of the cleaning fluid.

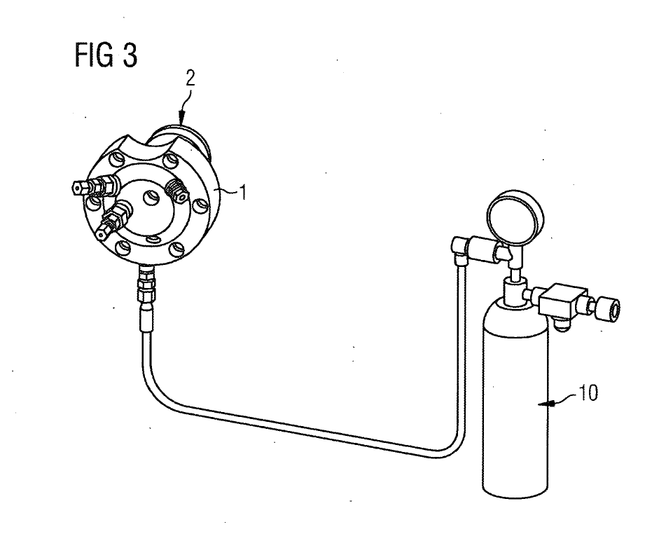

Referring to FIG. 3, the apparatus can include a cleaning fluid source 10 comprising a pressurised vessel having a size appropriate for portability or trolley mounting. A complete self-contained system is thus provided that can easily be brought to the location of the engine to facilitate component cleaning.

1.-6. (canceled)

7. A method of cleaning an engine component, comprising:
arranging a cap to provide a fluid seal with the engine component, wherein the cap includes an ultrasonic transducer;
directing a cleaning fluid to contact the component via a supply conduit;
agitating the cleaning fluid by means of the ultrasonic transducer; and
directing the cleaning fluid away from the engine component via a waste conduit.

8. The method as claimed in claim 7, wherein the engine component includes an internal fluid conduit and the cleaning fluid is directed to pass therethrough.

9. The method as claimed in claim 8, wherein the engine component comprises a gas turbine pilot burner.

10. An apparatus for cleaning an engine component with an internal fluid conduit, comprising:
a cap arranged to provide a fluid seal with the engine component, wherein the cap has an ultrasonic transducer;
a supply conduit arranged to direct cleaning fluid to enter the internal fluid conduit; and
a waste conduit arranged to collect cleaning fluid after exiting the internal fluid conduit.

11. The apparatus as claimed in claim 10, further comprising a portable cleaning fluid supply.

12. The apparatus as claimed in claim 11, wherein the portable cleaning fluid supply is a pressurized vessel.

13. The apparatus as claimed in claim 11, wherein the portable cleaning fluid is a reservoir.

14. The apparatus as claimed in claim 10, wherein the engine component is a gas turbine pilot burner.

15. A cleaning system, comprising:
a gas turbine pilot burner having an internal fluid conduit;
a cap arranged to provide a fluid seal with the gas turbine pilot burner, wherein the cap has an ultrasonic transducer;
a supply conduit arranged to direct cleaning fluid to enter the internal fluid conduit; and
a waste conduit arranged to collect cleaning fluid after exiting the internal fluid conduit.

16. The cleaning system as claimed in claim 15, wherein a fuel inlet is connected to the internal fluid conduit.

17. The cleaning system as claimed in claim 16, wherein the internal fluid conduit directs fuel to a nozzle.
